(19) United States
(12) Patent Application Publication
(10) Pub. No.: US 2022/0302496 A1
(43) Pub. Date: Sep. 22, 2022

(54) Solid Electrolytes and Methods

(71) Applicant: Florida State University Research Foundation, Inc., Tallahassee, FL (US)

(72) Inventors: Yan-Yan Hu, Tallahassee, FL (US); Sawankumar V. Patel, Tallahassee, FL (US); Erica Truong, Tallahassee, FL (US); Haoyu Liu, Tallahassee, FL (US)

(21) Appl. No.: 17/655,495

(22) Filed: Mar. 18, 2022

Related U.S. Application Data
(60) Provisional application No. 63/163,122, filed on Mar. 19, 2021.

(51) Int. Cl. H01M 10/0562

(52) U.S. Cl. CPC H01M 10/0562; H01M 2300/008

(57) ABSTRACT

Compounds, composites including compounds, and devices including the compounds. The compounds may be electrolytes used in devices, such as solid-state batteries. Methods for preparing compounds and composites. The methods may be performed in mild conditions, such as at room temperature.

### CROSS-REFERENCE TO RELATED APPLICATIONS

This application claims priority to U.S. Provisional Application No. 63/163,122, filed Mar. 19, 2021, which is incorporated by reference herein.

### BACKGROUND

Demand is increasing for cost effective, safe, stable, and/or high-density energy storage materials for industrial and commercial use. Current commercial batteries typically include organic liquid electrolytes that are typically flammable, and electrochemically and thermally unstable. Therefore, research has focused on finding alternatives that can replace these inefficient liquid electrolytes for high power applications, such as electrical devices. Upon the discovery of highly conductive solid electrolytes, all solid state batteries (ASSBs) are a candidate to replace the current commercial batteries (Dirican, M. et al., Composite Solid Electrolytes for All-Solid-State Lithium Batteries. Materials Science and Engineering: R: Reports 2019, 136, 27-46).

Numerous families of solid electrolytes, such as Garnet, NASICON, LiSICON, and halide-based have been investigated to determine the best candidate for ASSB's (Zhao, Q. et al. Designing Solid-State Electrolytes for Safe, Energy-Dense Batteries. Nature Reviews Materials 2020, 5 (3), 229-252).

Most, if not all, of the preeminent solid electrolytes require advanced design and synthesis conditions and/or expensive precursors, which make it difficult, if not impossible, to produce the materials on an industrial scale (Han, L. et al. Recent Developments and Challenges in Hybrid Solid Electrolytes for Lithium-Ion Batteries. Frontiers in Energy Research 2020, 8, 202). For example, the electrolytes can require high sintering temperatures of >1100° C. and/or advanced synthesis techniques, such as spark plasma sintering, which can increase the cost of production (Dong, Z. et al., Dual Substitution and Spark Plasma Sintering to Improve Ionic Conductivity of Garnet Li7La3Zr2O12. Nanomaterials 2019, 9 (5), 721).

There remains a need for electrolytes, including solid electrolytes and/or electrolytes with high conductivities, that can be produced with relatively simple synthesis techniques, cost-effective precursors, or a combination thereof.

### BRIEF SUMMARY

Provided herein are compounds and composites, which may include mixed-anion materials. The compounds and composites may be used as solid electrolytes in a number of devices, such as solid-state lithium-ion batteries. The solid electrolytes may have a relatively high ionic conductivity at room temperature or otherwise. Also provided herein are methods of forming compounds and composites, including cost-effective room-temperature methods that may be used to produce metastable solid electrolytes of formula Li_{3+x+y}M₁₋ₓNₓO₄Q_{y} from readily available, low-cost precursors, such as Li₃₊ₓM₁₋ₓNₓO₄ and LiQ. In some embodiments, high energy mechanochemical ball milling is employed to initiate the formation of the compounds or composites. Electrochemical cycling may be used to facilitate or optimize the formation of a metastable phase. In some embodiments, high ionic conductivities may be achieved, such as up to or beyond 0.15 mS/cm. In some embodiments, a lithium phosphate material (e.g., Li₃PO₄) combined with LiI results in a metastable phase that can improve total conductivity of the electrolytes described herein.

In one aspect, compounds and composites are provided. In some embodiments, the compounds are of Formula I:

Li_{3+x+y}M₁₋ₓNₓO₄Q_{y} Formula I;
wherein (i) 0≤x≤2, (ii) 0≤y≤1, (iii) M is an element having an oxidation number of +5, (iv) N is an element having an oxidation number of +4, and (v) Q is a halogen having an oxidation number of −1. The composites may include a compound of Formula I, and one or more byproducts or precursors of methods described herein.

In another aspect, devices are provided, such as electronic devices. In some embodiments, the devices include an electrolyte, wherein the electrolyte includes a compound or a composite, as described herein. The devices may include batteries, sensors, and membranes.

In a further aspect, methods for producing compounds and/or composites are provided. In some embodiments, the methods include contacting Li₃₊ₓM₁₋ₓNₓO₄ and LiQ to form a mixture comprising a compound of Formula I—

Li_{3+x+y}M₁₋ₓNₓO₄Q_{y} Formula I;
wherein (i) 0≤x≤2, (ii) 0≤y≤1, (iii) M is an element having an oxidation number of +5, (iv) N is an element having an oxidation number of +4, and (v) Q is a halogen having an oxidation number of −1. The methods may include milling Li₃₊ₓM₁₋ₓNₓO₄ and LiQ. The methods may include electrochemical cycling.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF SUMMARY OF THE DRAWINGS

FIG. 1A depicts a schematic of the structure of an embodiment of a compound herein in a crystalline form.

FIG. 1B depicts a schematic of the structure of an embodiment of a compound herein in an amorphous form.

FIG. 2 depicts a simulated powder X-ray diffraction (XRD) pattern of an embodiment of a compound described herein.

FIG. 3A is a schematic of an embodiment of a method described herein.

FIG. 3B depicts various X-ray diffraction patterns, including an X-ray diffraction pattern of an embodiment of a compound described herein.

FIG. 3C depicts differential scanning calorimetry data collected from an embodiment of a compound described herein.

FIG. 4A depicts various X-ray diffraction patterns of ball-milled or dried materials, including an X-ray diffraction pattern of an embodiment of a compound described herein.

FIG. 4B depicts various X-ray diffraction patterns of ball-milled or dried materials, including an X-ray diffraction pattern of an embodiment of a compound described herein.

FIG. 5 depicts a phase analysis of as-milled LiI.

FIG. 6A depicts ⁶Li nuclear magnetic resonance (NMR) of embodiments of compounds described herein.

FIG. 6B depicts density functional theory (DFT) NMR calculations of embodiments of compounds described herein.

FIG. 7 depicts high-resolution ³¹P NMR analysis of embodiments of composite electrolytes.

FIG. 8 depicts high-resolution ¹²⁷I NMR analysis of embodiments of composite electrolytes.

FIG. 9A depicts 2D ⁷Li/⁷Li Nuclear Overhauser Effect Spectroscopy (NOESY) NMR spectra of an embodiment of a composite electrode with mixing time of 0.1 ms.

FIG. 9B depicts 2D ⁷Li/⁷Li Nuclear Overhauser Effect Spectroscopy NMR spectra of an embodiment of a composite electrode with mixing time of 5 ms.

FIG. 9C depicts 2D ⁷Li/⁷Li Nuclear Overhauser Effect Spectroscopy NMR spectra of an embodiment of a composite electrode with mixing time of 100 ms.

FIG. 10A depicts ⁶Li NMR of pristine and cycled embodiments using natural abundant Li (^{nat.}Li) and ⁶Li.

FIG. 10B depicts quantifications of the Li components of embodiments of compounds described herein.

FIG. 10C depicts a relative change of ⁶Li ratio among embodiments of the compounds described herein.

FIG. 11 depicts the ionic conductivities of embodiments of compounds described herein.

FIG. 12 depicts electrochemical impedance spectroscopy of embodiments of compounds described herein.

FIG. 13 depicts electrochemical impedance spectroscopy of embodiments of as-milled compounds described herein.

FIG. 14 depicts electrochemical impedance spectroscopy of as-milled LiI.

FIG. 15A depicts an Arrhenius plot of experimental ionic conductivity measurements collected from an embodiment of a compound described herein.

FIG. 15B depicts calculated lithium ion diffusivities (D) at various temperatures (T) for a glassy phase of an embodiment of a compound described herein.

FIG. 16A depicts lithium ion trajectories of an embodiment of a compound described herein using ab initio molecular dynamics (AIMD) simulations at 500 K.

FIG. 16B depicts lithium ion trajectories of an embodiment of a compound described herein using ab initio molecular dynamics simulations at 600 K.

FIG. 16C depicts lithium ion trajectories of an embodiment of a compound described herein using ab initio molecular dynamics simulations at 700 K.

FIG. 16D depicts lithium ion trajectories of an embodiment of a compound described herein using ab initio molecular dynamics simulations at 800 K.

FIG. 16E depicts lithium ion trajectories of an embodiment of a compound described herein using ab initio molecular dynamics simulations at 1000 K.

FIG. 17 depicts the results of an electronic conductivity measurement of an embodiment of a composite material described herein.

### DETAILED DESCRIPTION

Provided herein are compounds, composites, methods, and electronic devices.

### Compounds and Composites

Provided herein are compounds and composites, which may be used as electrolytes. In some embodiments, the compounds and composites are mixed-anion materials.

In some embodiments, the compounds are of Formula I:

Li_{3+x+y}M₁₋ₓNₓO₄Q_{y} Formula I;

wherein (i) 0≤x≤2, (ii) 0≤y≤1, (iii) M is an element having an oxidation number of +5, (iv) N is an element having an oxidation number of +4, and (v) Q is a halogen having an oxidation number of −1. The halogen may be F, Cl, Br, or I.

In some embodiments, the composites include a compound of Formula I and at least one other material, such as a byproduct or precursor of the methods described herein. The one or more byproducts or precursors may include Li₃MO₄, LiQ, etc. In the composites described herein, a compound of Formula I may form a metastable phase between one or more disordered materials, such as Li₃MO₄, LiQ, etc.

In some embodiments, the compound of Formula I is Li₄PO₄I. When the compound of Formula I is Li₄PO₄I, the composites described herein may include Li₄PO₄I, Li₃PO₄, and LiI. Such a composite material may include a metastable phase (Li₄PO₄I) between the disordered Li₃PO₄ and LiI.

In some embodiments, the compounds are of Formula I, wherein x is 0, wherein y is 1, or wherein x is 0 and y is 1.

In some embodiments, the compounds are of Formula I, wherein M is P. In some embodiments, the compounds are of Formula I, (i) wherein M is P, and (ii) wherein x is 0, wherein y is 1, or wherein x is 0 and y is 1.

In some embodiments, the compounds are of Formula I, wherein Q is I. In some embodiments, the compounds are of Formula I, (i) wherein Q is I, (ii) wherein M is P, (iii) wherein x is 0, wherein y is 1, or wherein x is 0 and y is 1, or (iv) a combination thereof.

In Formula I, M may be selected from any element having any oxidation number of +5. In some embodiments, M is selected from the group consisting of P, Sb, and As. In some embodiments, M is P.

In Formula I, N may be selected from any element having an oxidation number of +4. In some embodiments, N is selected from the group consisting of Si, Ge, and Sn.

In some embodiments, at least a portion of the compound of Formula I has a crystalline structure. In some embodiments, at least a portion of the compound of Formula I has an amorphous structure. For example, a compound of Formula I may have a structure that is entirely crystalline, entirely amorphous, partially crystalline, or partially amorphous. Therefore, in some embodiments, at least a portion of the compound has a crystalline structure, and/or at least a portion of the compound has an amorphous structure. In some embodiments, the composites described herein include a metastable phase of a compound of Formula I, which may appear between disordered phases of one or more other materials in the composites.

The compounds and composites described herein may be in any phase or form. The compounds of Formula I or composites that include Formula I may be solids at room temperature and pressure. The solids may be any form (e.g., monolithic, particulate (e.g., a powder), etc.). In some embodiments, the compound is in the form of a powder. A “powder” is a form that may be achieved by milling the precursors as described herein. When the compounds or composites are in a particulate form, e.g., a powder, the particles may be of any desired size or shape.

The compounds and composites described herein may have relatively high ionic conductivities. In some embodiments, the compounds or composites have an ionic conductivity of at least 0.05 mS/cm, at least 0.1 mS/cm, or at least 0.15 mS/cm at room temperature.

### Devices

Also provided herein are devices, such as electronic devices, that include a compound of Formula I or a composite, as described herein. A compound of Formula I or a composite, as described herein, may be an electrolyte in the devices.

The devices described herein may include batteries, such as all-solid-state batteries, lithium ion batteries, solid-state lithium-ion batteries, etc. The devices described herein may include an electrochemical sensor, or a flow-battery membrane.

The electronic devices described herein generally may be used in any appliance, including, but not limited to, automobiles or other vehicles.

### Methods

Methods for producing compounds of Formula I and composites including a compound of Formula I are described herein. The methods described herein may be performed at or near room temperature and/or with cost-effective precursors.

In some embodiments, the methods include contacting Li₃₊ₓM₁₋ₓNₓO₄ and LiQ to form a mixture comprising a compound of Formula I—

Li_{3+x+y}M₁₋ₓNₓO₄Q_{y} Formula I;

wherein (i) 0≤x≤2, (ii) 0≤y≤1, (iii) M is an element having an oxidation number of +5, (iv) N is an element having an oxidation number of +4, and (v) Q is a halogen having an oxidation number of −1.

Prior to the contacting the precursors (i.e., Li₃₊ₓM₁₋ₓNₓO₄ and LiQ), the precursors may be dried, optionally under vacuum, to remove or reduce moisture.

In some embodiments, the contacting of Li₃₊ₓM₁₋ₓNₓO₄ and LiQ includes milling the Li₃₊ₓM₁₋ₓNₓO₄ and LiQ. For example, the precursors may be ball milled as described in the examples herein.

Generally, any weight ratio of the precursors may be contacted to form the compounds of Formula I. In some embodiments, based on the weight of the mixture formed by contacting the two precursors, about 50 wt % to about 70 wt % of Li₃₊ₓM₁₋ₓNₓO₄ is contacted with about 30 wt % to about 50 wt % of LiQ. In some embodiments, based on the weight of the mixture formed by contacting the two precursors, about 50 wt % to about 60 wt % of Li₃₊ₓM₁₋ₓNₓO₄ is contacted with about 40 wt % to about 50 wt % of LiQ. In some embodiments, based on the weight of the mixture formed by contacting the two precursors, about 55 wt % of Li₃₊ₓM₁₋ₓNₓO₄ is contacted with about 45 wt % of LiQ.

In some embodiments, the methods also include subjecting the mixture of precursors to electrochemical cycling. The electrochemical cycling may be performed before, during, and/or after the contacting of the precursors. Subjecting the mixture to electrochemical cycling may include contacting a mixture with one or more electrodes, such as a ⁶Li electrode and/or a ^{nat.}Li electrode.

In some embodiments, the methods include contacting Li₃PO₄ and LiI. It was surprisingly discovered that embodiments of the highly conductive compounds and composites described herein could be produced by mixing two poorly conductive precursors-such as, for example, LiI and Li₃PO₄—at room temperature. Not wishing to be bound by any particular theory, it is believed that electrochemical cycling of some embodiments of the compounds or composites described herein can accelerate the production of a kinetically stabilized phrase, such as a kinetically stabilized Li₄PO₄I phase, by consuming all, or most of, the LiQ (e.g., LiI). Also, lithium-ion conduction of the solid electrolytes described herein, such as include a Li₃PO₄—LiI composite, may be facilitated, at least in part, by the formation of a metastable phase (e.g., Li₄PO₄I) between the disordered materials, such as Li₃PO₄ and LiI, which can permit lithium to “hop” to and from the highly polarizable anions, such as phosphate and iodide anions.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When compounds, devices, or methods are claimed or described in terms of “comprising” various steps or components, the compounds, devices, or methods can also “consist essentially of” or “consist of” the various steps or components, unless stated otherwise.

The terms “a,” “an,” and “the” are intended to include plural alternatives, e.g., at least one. For instance, the disclosure of “an electrolyte”, “a lithium halide”, and the like, is meant to encompass one, or mixtures or combinations of more than one electrolyte, lithium halide, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, about 50 wt % to about 60 wt % of Li₃₊ₓM₁₋NₓO₄ is contacted with another material. This range should be interpreted as encompassing about 50 wt % and about 60 wt %, and further encompasses “about” each of 51 wt %, 52 wt %, 53 wt %, 54 wt %, 55 wt %, 56 wt %, 57 wt %, 58 wt %, and 59 wt %, including any ranges and sub-ranges between any of these values. As a further representative example, Applicant discloses, in some embodiments, that “0≤y≤1”. This range should be interpreted as encompassing 0 and 1, and further encompasses “about” each of 0.1, 0.2, 0.3, 0.4, 0.5, 0.6, 0.7, 0.8, and 0.9, including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof, which, after reading the description herein, may suggest themselves to one of ordinary skill in the art without departing from the spirit of the present invention or the scope of the appended claims. Therefore, other aspects of this invention will be apparent to those skilled in the art from consideration of the specification and practice of the invention disclosed herein.

### Example 1—Synthesis of an Embodiment of a Solid Electrolyte

Lithium iodide (99.9% Alfa Aesar) and lithium phosphate (99% Sigma Aldrich) were initially dried at 120° C. under dynamic vacuum to remove moisture, and then stored in an argon glovebox. A stoichiometric amount of 55 wt. % Li₃PO₄—45 wt. % LiI was mixed in a 40 mL zirconia jar with 10 mm zirconia balls. Mechanochemical mixing of a Li₃PO₄—LiI composite was performed using a SPEX® 8000M MIXER/MILL® high-energy ball mill (SPEX® SamplePrep, USA) continuously for 20 hours. The as-milled powder was stored in an argon glovebox under low H₂O and 02 content of <2 ppm.

X-ray Diffraction (XRD)—Powder samples were finely grounded and packed in a zero-background sample holder. KAPTON® film (DUPONT™, USA) was used to seal the samples in order to prevent exposure to humid air. XRD was performed using a RIGAKU® D8 powder diffractometer with Bragg-Brentano geometry at a voltage of 45 kV and current of 40 mA with Cu-Kα radiation (λ=1.5406 Å). The data was collected from 10-80 2Θat a step size of 0.03 for 30 minutes.

Solid-state NMR—⁶Li, ⁷Li, and ³¹P Magic-Angle-Spinning (MAS) NMR experiments were performed using a BRUKER® Avance-III 500 spectrometer at Larmor frequencies of 73.6 MHz, 194.4 MHz, and 202.4 MHz, respectively. The MAS rate was 24 kHz. For ⁶Li and ⁷Li, single-pulse NMR experiments were performed using n/2 pulse lengths of 4.75 μs and 3.35 μs, respectively. The recycle delays were 1000 s for ⁶Li and 20 s for ⁷Li. For ³¹P, a rotor-synchronized spin-echo sequence was employed with a n/2 pulse length of 4.2 μs and a recycle delay of 1000 s. 2D Nuclear Overhauser effect spectroscopy (NOESY) experiments were acquired using a π/2 and π pulse lengths of 4.75 μs and 9.5 μs, respectively. The NOESY spectra was recorded using 1024 t1 increments and 8186 t2 complex points. Assignment of Li₄PO₄I component was accomplished by acquiring the 2D ⁷Li/⁷Li NOESY spectra at 0.1, 5, and 100 ms mixing times. ⁶-7Li and ³¹P NMR spectra were calibrated to LiCl₍ₛ₎ at −1.1 ppm and 85% H₃PO_{4(I)} at 0 ppm, respectively.

Electrochemical measurements—The ionic conductivity of Li₃PO₄—LiI composite electrolyte was determined based on AC impedance spectroscopy acquired using a Gamry Analyzer Reference 600+ with a frequency range of 5 MHz to 1 Hz. Indium foils were pressed on the surface of the pellet as blocking electrodes and the pellet was placed in a custom-built cylindrical cell. Impedance measurements were conducted using the CSZ Microclimate chamber within the temperature range of 20 to 120° C., over frequencies from 5 MHz to 1 Hz with an applied voltage of 10 mV.

AIMD simulation—All the density functional theory (DFT) calculations were performed using a Vienna ab initio simulation package (VASP) based on projector-augmented-wave method (Blöchl, P. E., Projector Augmented-Wave Method. Phys. Rev. B 1994, 50 (24), 17953-17979; and Kresse, G. et al., Efficient Iterative Schemes for Ab Initio Total-Energy Calculations Using a Plane-Wave Basis Set. Phys. Rev. B 1996, 54 (16), 11169-11186) with Perdew-Burke-Ernzerh of generalized-gradient approximation (PBE-GGA)(Perdew, J. P. et al., Generalized Gradient Approximation Made Simple. Phys. Rev. Lett. 1996, 77 (18), 3865-3868). A pristine structure of Li₄PO₄I was generated by replacing Ag⁺ with Li⁺ in the structure of Ag₄PO₄I retrieved from Inorganic Crystal Structure Database (ICSD No. 245791). Then the ion positions and the shape of the unit cell were optimized during the following structure relaxations. After the crystalline phase of Li₄PO₄I was determined, an ab initio molecular dynamics (AIMD) calculation was used to raise the temperature to 1000 K and maintained for 80 μs before the system was quenched to 0 K by repeating the structure relaxation in first step. Canonical ensemble was chosen for AIMD simulations with a time step of 2 fs. The temperature initializing at 100 K was elevated to appropriate temperature during the first 2 μs. A glassy phase of Li₄PO₄I was found by this process and then AIMD at different temperature (500 K, 600 K, 700 K, 800 K, 1000 K) with total simulation time of 120 μs and diffusivity rate was converged. The diffusivity analysis and conductivity/activation energy calculations was performed on the pymatgen (Wang, Y. et al., Design Principles for Solid-State Lithium Superionic Conductors. Nature Materials 2015, 14 (10), 1026-1031). The isotropic chemical shifts of relaxed structures were calculated by magnetic shieldings using perturbation theory (linear response)(Pickard, C. J. et al., All-Electron Magnetic Response with Pseudopotentials: NMR Chemical Shifts. Phys. Rev. B 2001, 63 (24), 245101; and Yates, J. R. et al., Calculation of NMR Chemical Shifts for Extended Systems Using Ultrasoft Pseudopotentials. Phys. Rev. B 2007, 76 (2), 024401). The calibration factor of ⁶Li (+89 ppm) was estimated from the difference between experimental and calculated isotropic shift of Li₃PO₄.

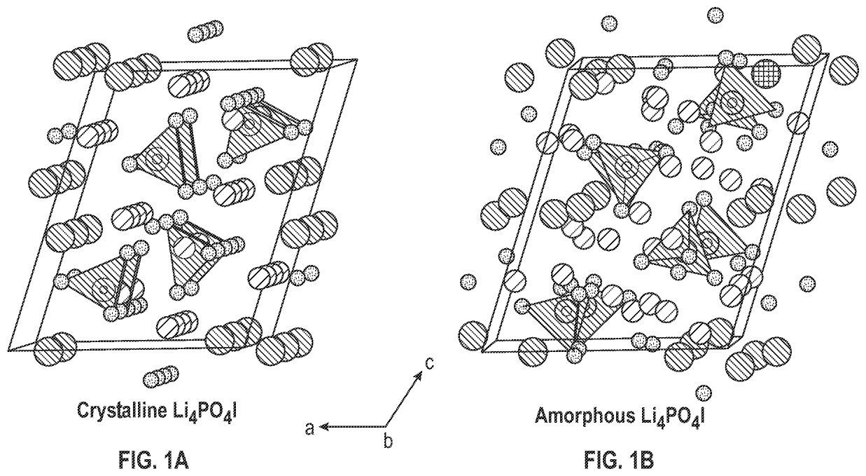

FIG. 1A and FIG. 1B are structural representations of Li₄PO₄I in both crystalline (FIG. 1A) and amorphous (FIG. 1B) form. Phosphorus could be substituted with a M (+5 oxidation Sb, As) or (+4 oxidation state Si, Ge, Sn). Iodine could be substituted with F, Cl, or Br. The stoichiometric composition of the phase was Li_{3+x+y}M₁₋ₓNₓO₄Q_{y}.

TABLE 1
Unit cell parameters of Li₄PO₄I

| space group | P1 |
|---|---|
| cell length a (Å) | 8.51433 |
| cell length b (Å) | 12.89772 |
| cell length c (Å) | 10.46679 |
| cell angle alpha (°) | 90 |
| cell angle beta (°) | 108.02 |
| cell_angle gamma (°) | 90 |
| cell volume (Å³) | 1093.01 |

TABLE 2
Structural parameters of the crystalline Li₄PO₄I phase

| Atom | | Occupancy | x | y | z |
|---|---|---|---|---|---|
| Li | Li1 | 1 | 0.60035 | 0.125 | 0.645334 |
| Li | Li2 | 1 | 0.60035 | 0.625 | 0.645334 |
| Li | Li3 | 1 | 0.39965 | 0.375 | 0.354666 |
| Li | Li4 | 1 | 0.39965 | 0.875 | 0.354666 |
| Li | Li5 | 1 | 0.641646 | 0.125 | 0.186152 |
| Li | Li6 | 1 | 0.641646 | 0.625 | 0.186152 |
| Li | Li7 | 1 | 0.358354 | 0.375 | 0.813848 |
| Li | Li8 | 1 | 0.358354 | 0.875 | 0.813848 |
| Li | Li9 | 1 | 0.618491 | −0.01129 | 0.939311 |
| Li | Li10 | 1 | 0.618491 | 0.488709 | 0.939311 |
| Li | Li11 | 1 | 0.381509 | 0.011291 | 0.060689 |
| Li | Li12 | 1 | 0.381509 | 0.511291 | 0.060689 |
| Li | Li13 | 1 | 0.381509 | 0.238709 | 0.060689 |
| Li | Li14 | 1 | 0.381509 | 0.738709 | 0.060689 |
| Li | Li15 | 1 | 0.618491 | 0.261291 | 0.939311 |
| Li | Li16 | 1 | 0.618491 | 0.761291 | 0.939311 |
| Li | Li17 | 1 | 0.687993 | −0.00291 | 0.463418 |
| Li | Li18 | 1 | 0.687993 | 0.497091 | 0.463418 |
| Li | Li19 | 1 | 0.312007 | 0.002909 | 0.536582 |
| Li | Li20 | 1 | 0.312007 | 0.502909 | 0.536582 |
| Li | Li21 | 1 | 0.312007 | 0.247091 | 0.536582 |
| Li | Li22 | 1 | 0.312007 | 0.747091 | 0.536582 |
| Li | Li23 | 1 | 0.687993 | 0.252909 | 0.463418 |
| Li | Li24 | 1 | 0.687993 | 0.752909 | 0.463418 |
| Li | Li25 | 1 | 0.029747 | −0.01079 | 0.242582 |
| Li | Li26 | 1 | 0.029747 | 0.489214 | 0.242582 |
| Li | Li27 | 1 | −0.02975 | 0.010786 | 0.757418 |
| Li | Li28 | 1 | −0.02975 | 0.510786 | 0.757418 |
| Li | Li29 | 1 | −0.02975 | 0.239214 | 0.757418 |
| Li | Li30 | 1 | −0.02975 | 0.739214 | 0.757418 |
| Li | Li31 | 1 | 0.029747 | 0.260786 | 0.242582 |
| Li | Li32 | 1 | 0.029747 | 0.760786 | 0.242582 |
| P | P1 | 1 | 0.366871 | 0.125 | 0.323253 |
| P | P2 | 1 | 0.366871 | 0.625 | 0.323253 |
| P | P3 | 1 | 0.633129 | 0.375 | 0.676747 |
| P | P4 | 1 | 0.633129 | 0.875 | 0.676747 |
| P | P5 | 1 | 0.309237 | 0.125 | 0.790631 |
| P | P6 | 1 | 0.309237 | 0.625 | 0.790631 |
| P | P7 | 1 | 0.690763 | 0.375 | 0.209369 |
| P | P8 | 1 | 0.690763 | 0.875 | 0.209369 |
| I | I1 | 1 | 0.87079 | 0.125 | 0.982219 |
| I | I2 | 1 | 0.87079 | 0.625 | 0.982219 |
| I | I3 | 1 | 0.12921 | 0.375 | 0.017781 |
| I | I4 | 1 | 0.12921 | 0.875 | 0.017781 |
| I | I5 | 1 | 0.916647 | 0.125 | 0.40458 |
| I | I6 | 1 | 0.916647 | 0.625 | 0.40458 |
| I | I7 | 1 | 0.083353 | 0.375 | 0.59542 |
| I | I8 | 1 | 0.083353 | 0.875 | 0.59542 |
| O | O1 | 1 | 0.365123 | 0.125 | 0.660162 |
| O | O2 | 1 | 0.365123 | 0.625 | 0.660162 |
| O | O3 | 1 | 0.634877 | 0.375 | 0.339838 |
| O | O4 | 1 | 0.634877 | 0.875 | 0.339838 |
| O | O5 | 1 | 0.534674 | 0.125 | 0.440373 |
| O | O6 | 1 | 0.534674 | 0.625 | 0.440373 |
| O | O7 | 1 | 0.465326 | 0.375 | 0.559627 |
| O | O8 | 1 | 0.465326 | 0.875 | 0.559627 |
| O | O9 | 1 | 0.399412 | 0.125 | 0.185297 |
| O | O10 | 1 | 0.399412 | 0.625 | 0.185297 |
| O | O11 | 1 | 0.600588 | 0.375 | 0.814703 |
| O | O12 | 1 | 0.600588 | 0.875 | 0.814703 |
| O | O13 | 1 | 0.119955 | 0.125 | 0.759853 |
| O | O14 | 1 | 0.119955 | 0.625 | 0.759853 |
| O | O15 | 1 | 0.880045 | 0.375 | 0.240147 |
| O | O16 | 1 | 0.880045 | 0.875 | 0.240147 |
| O | O17 | 1 | 0.72831 | 0.476105 | 0.662198 |
| O | O18 | 1 | 0.72831 | 0.976105 | 0.662198 |
| O | O19 | 1 | 0.27169 | 0.023895 | 0.337802 |
| O | O20 | 1 | 0.27169 | 0.523895 | 0.337802 |
| O | O21 | 1 | 0.27169 | 0.226105 | 0.337802 |
| O | O22 | 1 | 0.27169 | 0.726105 | 0.337802 |
| O | O23 | 1 | 0.72831 | 0.273895 | 0.662198 |
| O | O24 | 1 | 0.72831 | 0.773895 | 0.662198 |
| O | O25 | 1 | 0.384663 | 0.026928 | 0.874879 |
| O | O26 | 1 | 0.384663 | 0.526928 | 0.874879 |
| O | O27 | 1 | 0.615336 | 0.473072 | 0.125121 |
| O | O28 | 1 | 0.615336 | 0.973072 | 0.125121 |
| O | O29 | 1 | 0.615336 | 0.276928 | 0.125121 |
| O | O30 | 1 | 0.615336 | 0.776928 | 0.125121 |
| O | O31 | 1 | 0.384663 | 0.223072 | 0.874879 |
| O | O32 | 1 | 0.384663 | 0.723072 | 0.874879 |

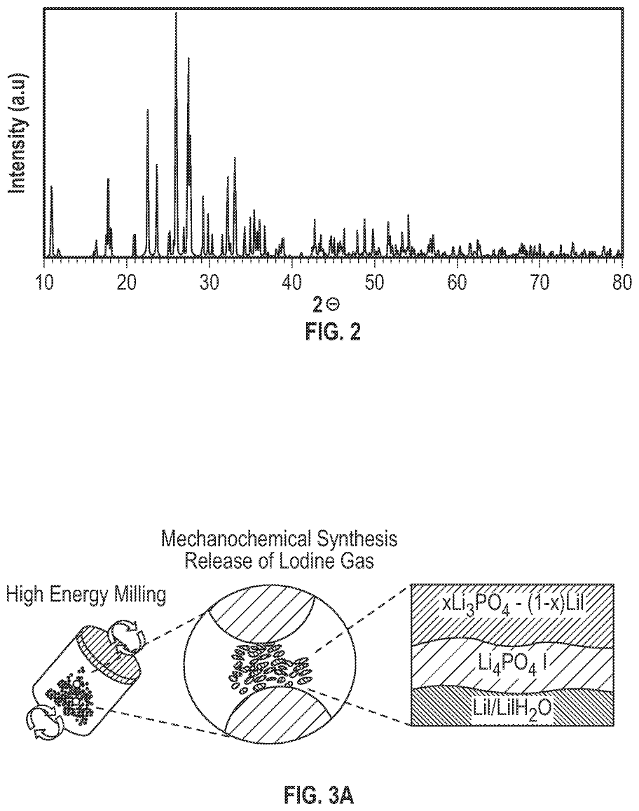

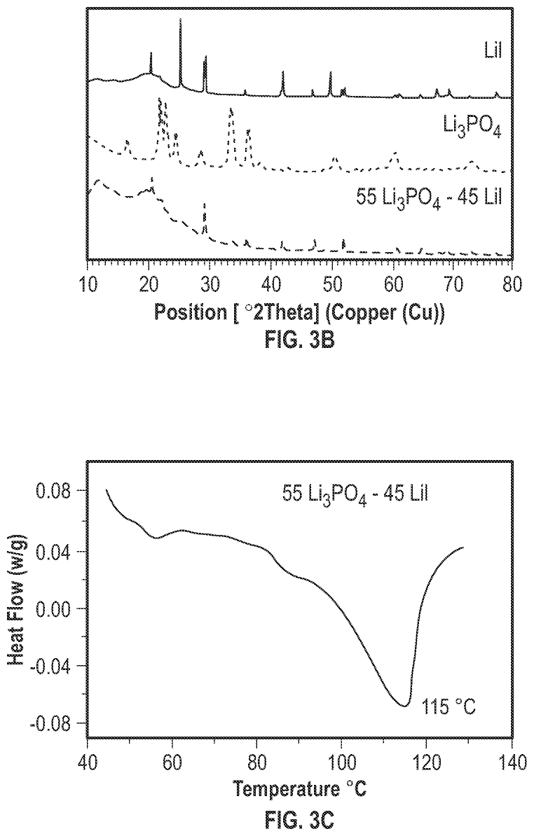

FIG. 2 depicts a simulated Powder XRD pattern of Li₄PO₄I. FIG. 3A-FIG. 3C depict synthesis and phase analysis of 55 wt. % Li₃PO₄—45 wt. % LiI composite electrolyte. FIG. 3A is a schematic representation of an embodiment of a room-temperature synthesis approach via mechanochemical high-energy milling that resulted in a composite mixture of xLi₃PO₄-(1−x)LiI, Li₄PO₄I, and LiI.H₂O phases. FIG. 3B depicts X-ray powder diffractions of as-milled samples Li₃PO₄, LiI, and 55 wt. % Li₃PO₄—45 wt. % LiI. FIG. 3C depicts the results of a differential scanning calorimetry (DSC) analysis of 55 wt. % Li₃PO₄—45 wt. % LiI.

In this example, high-energy mechanochemical ball milling was utilized to synthesize the composite solid electrolyte, as depicted at FIG. 3A. A stoichiometric amount of dry Li₃PO₄ and LiI were subjected to high mechanical stress during ball milling, which resulted in nano-sized samples and the formation of a metastable Li₄PO₄I. Iodine gas was released during the synthesis.

The evolution of iodine gas was tested by observing the color change of starch solution from white to dark blue. Specifically, an iodine gas test was performed with a solution of starch dissolved in water. A dark color was observed for the solution with iodine gas, and tube containing a clear solution was used as a control.

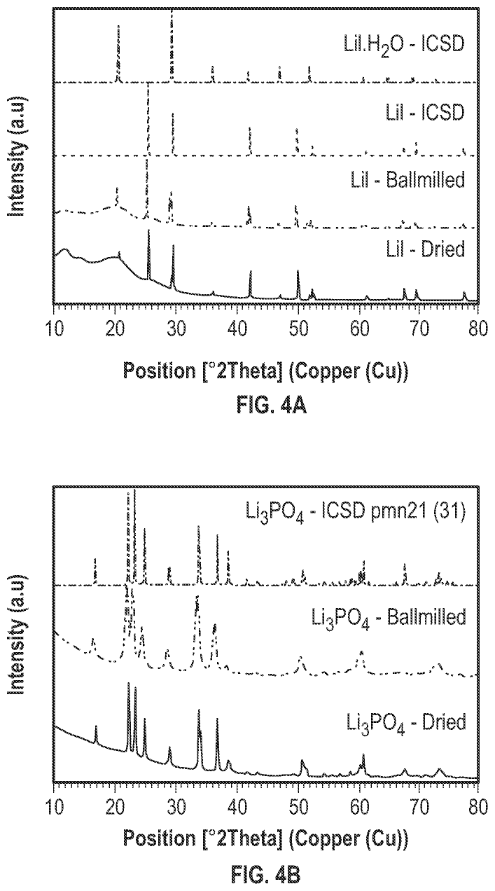

Powder XRD of LiI, Li₃PO₄ and, 55 wt. % Li₃PO₄—45 wt. % LiI composite electrolyte was collected for structural analysis (FIG. 3B). FIG. 4A and FIG. 4B depict powder XRD data collected from pristine and as-milled precursor samples of LiI (FIG. 4A) and Li₃PO₄ (FIG. 4B). An LiI phase exhibited both the rock salt structure (Fm3m) with a minor hydrate phase LiI.H₂O (Fig S2).

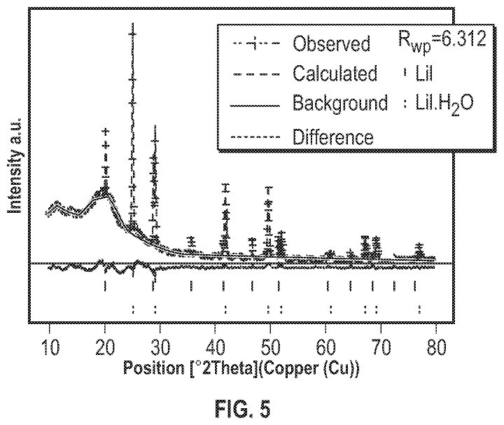

A phase analysis from Rietveld refinement revealed a phase fraction of ˜37.9 wt. % of the minor hydrated phase LiI.H₂O (FIG. 5).

Powder XRD of Li₃PO₄ was indexed to β-Li₃PO₄ (space group pmn21) which was the energetically stable phase of Li₃PO₄ at room temperature. As-milled Li₃PO₄ resulted in broad Bragg peaks signifying nano-sized crystallites. Surprisingly, the powder XRD of 55 wt. % Li₃PO₄—45 wt. % LiI composite showed major Bragg reflections indicative of crystalline LiI and LiI—H₂O phase. The minor Bragg reflections from Li₃PO₄ phase in the composite likely indicated a weakened long-range order. Due to poor crystallinity, powder XRD was not sufficient to understand the structure of the 55 wt. % Li₃PO₄—45 wt. % LiI composite. DSC analysis of 55 wt. % Li₃PO₄—45 wt. % LiI is depicted at FIG. 3C, and shows a exothermic peak at 115° C.

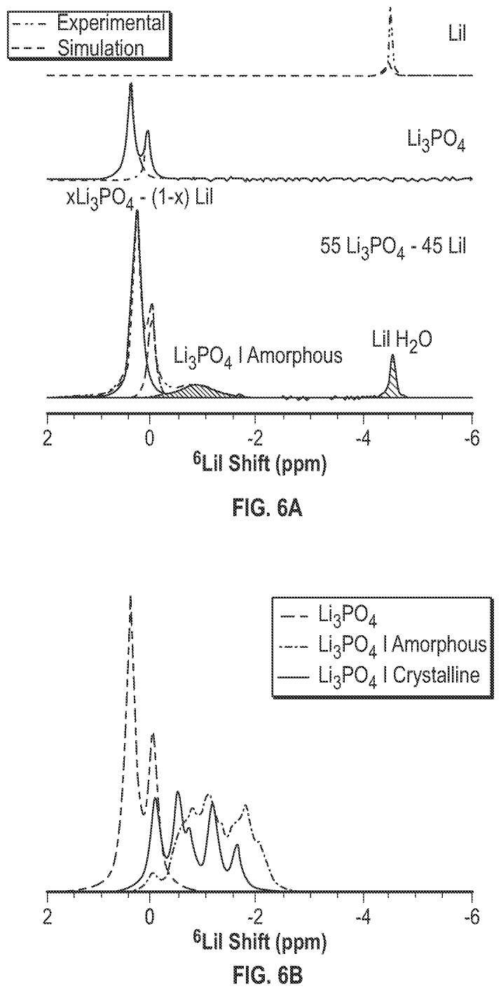

FIG. 6A and FIG. 6B depict the results of a high-resolution ⁶Li NMR analysis of 55 wt. % Li₃PO₄—45 wt. % LiI. FIG. 6A depicts ⁶Li NMR of as-milled LiI, Li₃PO₄, and 55 wt. % Li₃PO₄—45 wt. % LiI. FIG. 6B depicts DFT NMR calculation of Li₃PO₄, crystalline Li₄PO₄I, and amorphous Li₄PO₄I phases.

For materials that lack long-range order, local structural analysis helped recognize the phases. High-resolution ⁶Li NMR was acquired to determine the local structural changes of 55 wt. % Li₃PO₄—45 wt. % LiI composite. FIG. 6A depicts the ⁶Li NMR of LiI, Li₃PO₄, and the composite 55 wt. % Li₃PO₄—45 wt. % LiI. LiI resonated at about −4.5 ppm whereas Li₃PO₄ resonated at about 0.3 ppm. There was a small shoulder peak resonating upfield of LiI main peak, which was assigned to a hydrate form LiI.H₂O, which was also detected in the foregoing powder XRD measurements.

Quantification of LiI and LiI—H₂O from NMR and XRD is presented in the following table:

| Phase | ⁶Li NMR (wt. %) | XRD (wt. %) |
|---|---|---|
| LiI | 68.9 | 62.1 |
| LiI•H₂O | 31.1 | 37.9 |

⁶Li NMR of Li₃PO₄ displayed two resonances at 0.32 and 0.04 ppm in the ratio of 2.6:1, respectively, which was attributed to β-Li₃PO₄ phase (Hartley, G. O. et al., Is Nitrogen Present in Li3N.P2S5 Solid Electrolytes Produced by Ball Milling? Chem. Mater. 2019, 31 (24), 9993-10001). Contrastingly, 55 wt. % Li₃PO₄—45 wt. % LiI composite exhibited the LiI.H₂O, disordered Li₃PO₄ and a new metastable phase Li₄PO₄I. The chemical shift of disordered Li₃PO₄ phase in the 55Li₃PO₄—45LiI composite shifts upfield, likely due to local structural changes by the close proximity of LiI. This was also evident from weak Bragg reflections observed in the powder XRD. The ratio of the two Li₃PO₄ peaks at 0.3 and 0.04 ppm observed in 55Li₃PO₄—45LiI composite was ˜2.7:1. The peak resonating at −0.7 ppm was assigned to a new metastable phase Li₄PO₄I. The calculated chemical shift of ⁶Li in the Li₄PO₄I was determined by DFT calculations as shown in FIG. 6B. Both the amorphous and crystalline Li₄PO₄I had similar average chemical shift, however due to absence of Bragg peaks, the new phase was assigned to amorphous Li₄PO₄I.

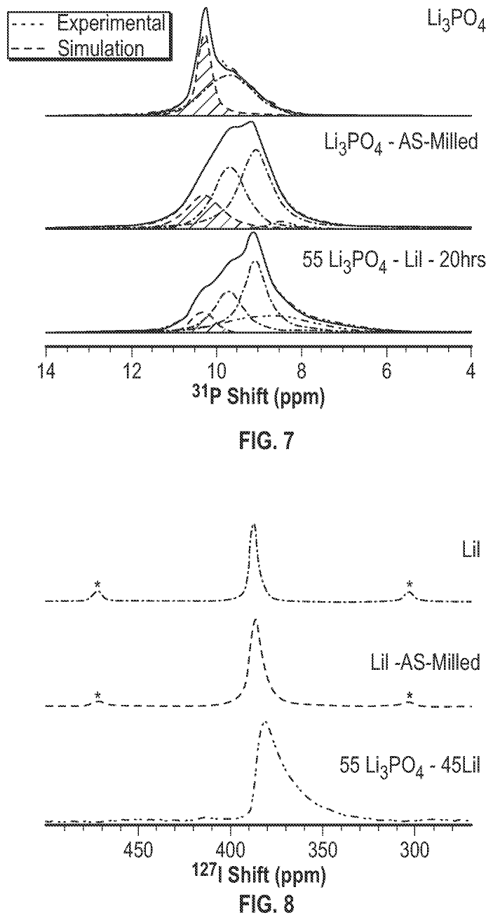

FIG. 7 depicts high-resolution ³¹P NMR analysis of the composite electrolyte 55Li₃PO₄—45LiI and pristine Li₃PO₄.

High-resolution ³¹P NMR was employed to understand the local structural changes in the phosphate (PO₄³⁻) network. Phosphate framework are formed by rigid covalent bond between P—O pairs. Several local configurations of phosphates have been characterized such as isolated PO₄³⁻, corner-sharing P₂O₇⁴⁻, and bridged P₂O₆²⁻.

FIG. 7 depicts a ³¹P NMR of pristine Li₃PO₄, as-milled Li₃PO₄ and 55 wt. % Li₃PO₄—45 wt. % LiI composite. Pristine Li₃PO₄ displayed 2 resonances at 10.2 and 9.7 ppm that represented the crystalline and amorphous Li₃PO₄, respectively. The as-milled Li₃PO₄ displayed an increased component of the amorphous fraction. 55 wt. % Li₃PO₄—45 wt. % LiI composite displayed narrow line shape that may be affected by the near neighbor iodide anion interaction.

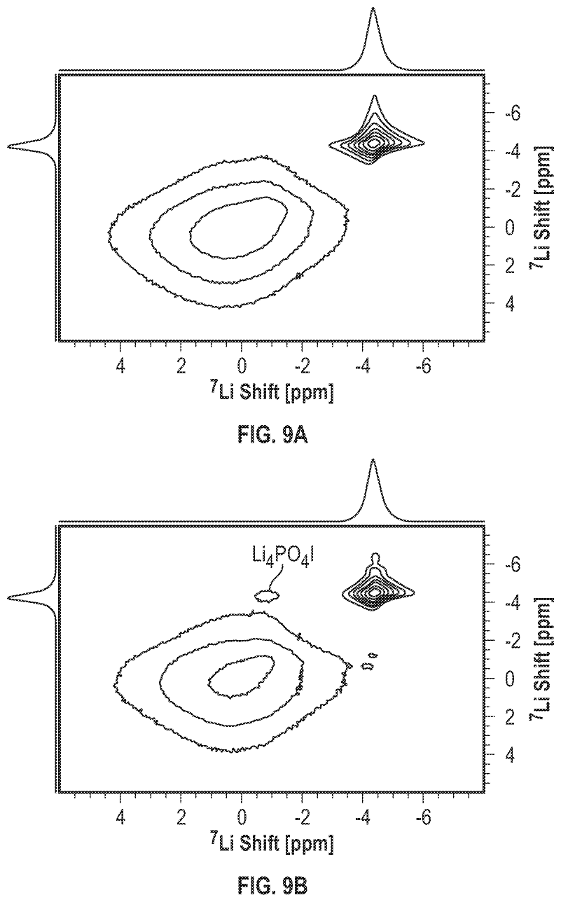

FIG. 8 depicts the result of a high-resolution ¹²⁷I NMR analysis of composite electrolyte 55Li₃PO₄—45LiI and pristine LiI.

¹²⁷I NMR was employed to determine the local environment iodide local environment as shown at FIG. 8. Pristine LiI and as-milled LiI displayed a symmetric peak resonating at 387 ppm with spinning sidebands signifying a symmetric environment. There was a slight change in chemical shift with huge asymmetry on the 55 wt. % Li₃PO₄—45 wt. % LII composite signifying distorted local environment. Iodine was a half integer quadrupole nucleus with spin 5/2. This resulted in huge quadrupole coupling constants (Cq) of iodine in a disordered environment.

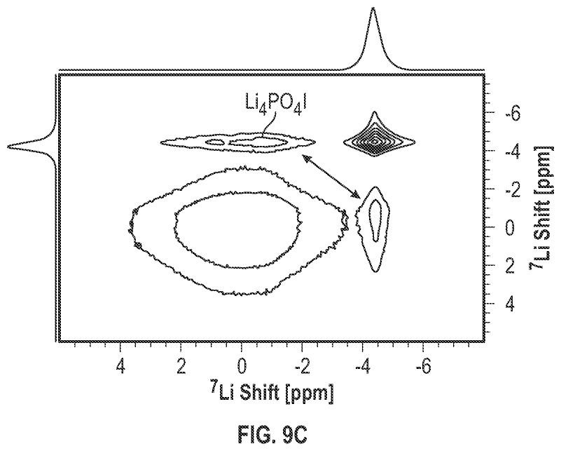

Also studied was the spatial structure of 55 wt. % Li₃PO₄—45 wt. % LII composite electrolyte from 2D ⁷Li/⁷Li NOESY NMR spectra with mixing times of (FIG. 9A) 0.1 ms, (FIG. 9B) 5 ms, and (FIG. 9C) 100 ms.

The relative spatial structure of 55Li₃PO₄—45LiI was investigated by 2D ⁷Li/⁷Li NOESY NMR. 2D NOESY NMR was useful in describing the interaction of nuclear spins with neighboring spins through space (Zheng, J. et al. Lithium Ion Pathway within Li7La3Zr2O12-Polyethylene Oxide Composite Electrolytes. Angewandte Chemie International Edition 2016, 55 (40), 12538-12542). A diagonal peak in 2D NMR resulted from the spins without any interactions among neighboring spins. An emergence of a cross peak indicated interaction of a spin with a neighboring spin through transfer of magnetization. The intensity of cross peak was dictated by the mixing time provided for the magnetization transfer to take place. FIG. 9A-FIG. 9C depict the ⁷Li/⁷Li 2D NOESY NMR collected at various mixing times. At an extremely short mixing time of 0.1 ms, only two diagonal peaks were observed at ˜0 ppm and −4.5 ppm signifying no polarization transfer among the ⁷Li of LiI, Li₃PO₄, and Li₄PO₄I. The existence of cross peaks at −0.7 ppm became prominent at longer mixing times of 5 and 100 ms. This indicated that the Li₄PO₄I resonating around −0.7 ppm was in close proximity to the LII and Li₃PO₄ phase.

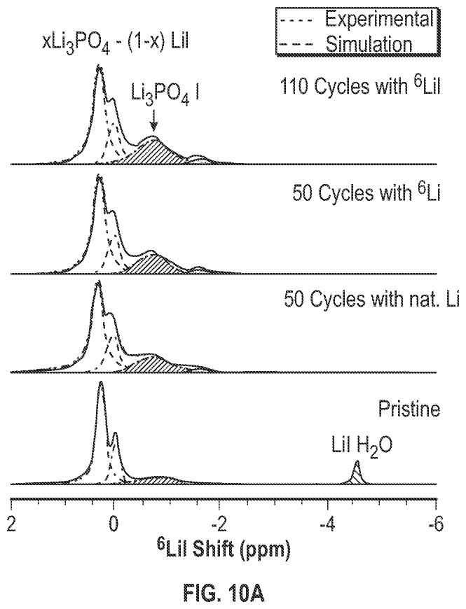

Li⁺ ion pathways within the 55Li₃PO₄—45LiI composite were determined by ⁶Li tracer exchange NMR. Symmetric cells of a composite electrolyte with ⁶Li electrode were assembled and cycled at 50 and 110 cycles using a constant current density of 10 mA/cm². Alternative symmetric cells with natural abundant lithium were assembled to serve as a control. FIG. 10A depicts the ⁶Li NMR of the pristine and cycled samples using natural abundant Li (^{nat.}Li) and ⁶Li. The pristine sample presented three resonances that resembled LII, Li₃PO₄ and Li₄PO₄I. Symmetric cycling using both ⁶Li and ^{nat.}Li electrode resulted in the LiI phase converting to Li₄PO₄I −0.7.

Quantification of the Li components is presented at FIG. 10B. In comparison to the pristine and control sample (^{nat.}Li), the samples cycled with ⁶Li electrode showed significant growth of the Li₄PO₄I component. Evaluation on the relative change of ⁶Li ratio in the Li₃PO₄ and Li₄PO₄I phase is depicted at FIG. 10C. The exchange of ⁶Li in the Li₃PO₄ phase upon cycling was very minimal, however the Li₄PO₄I phase showed a drastic change during cycling. This signified that Li⁺ ion had a preference to diffuse through the metastable Li₄PO₄I than Li₃PO₄, resulting in enrichment of ⁶Li isotope in the component.

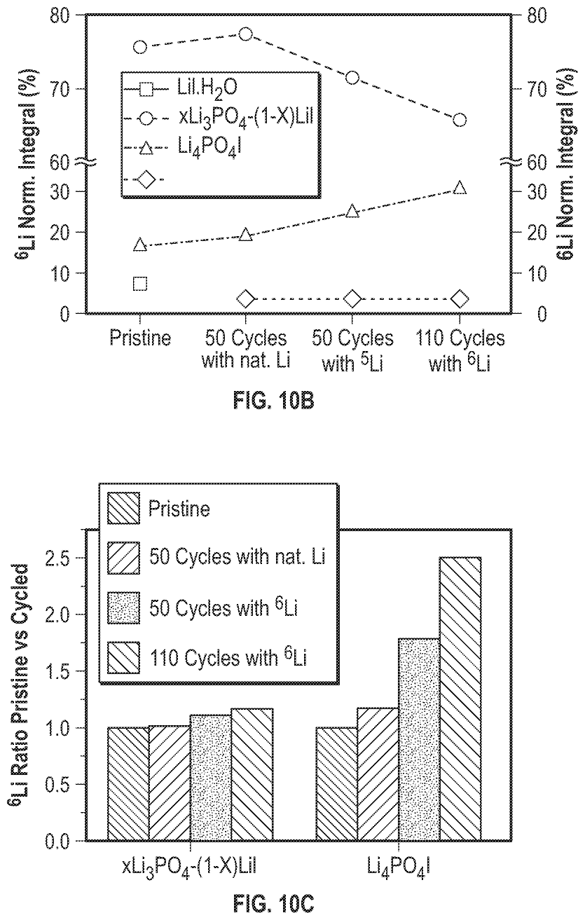

EIS measurements revealed the Li₃PO₄—LiI composite achieved a conductivity of 0.15 mS/cm at an optimal composition of 55Li₃PO₄—45LiI (wt. %) (FIG. 11). FIG. 11 depicts ionic conductivities of various compositions of (1−x)Li₃PO₄-xLiI in (wt. %).

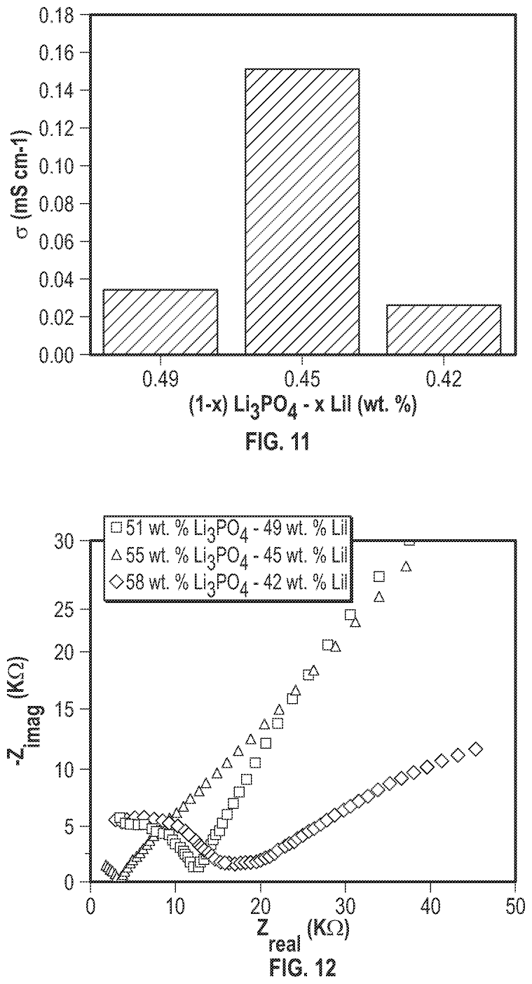

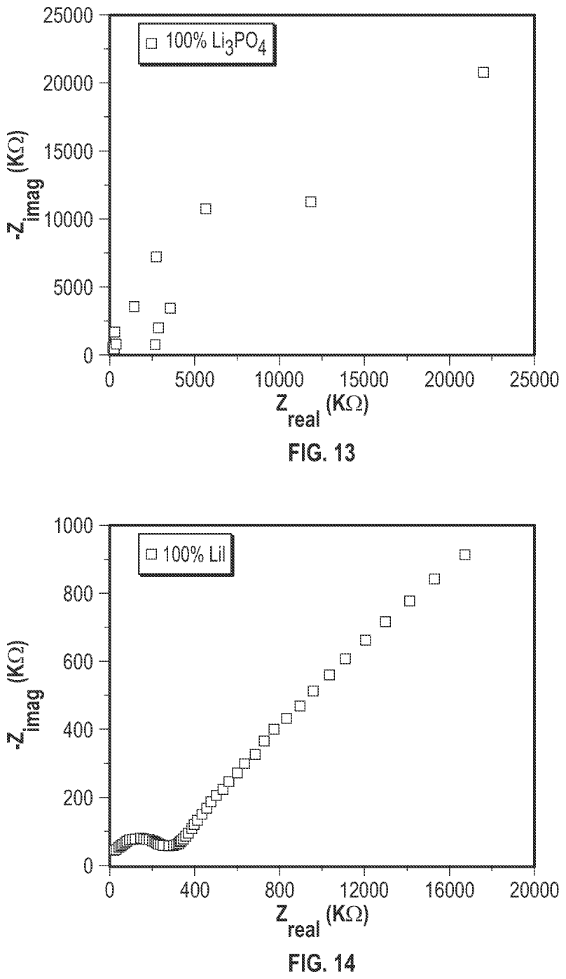

The conductivity of the composite 55Li₃PO₄—45LiI was at least three-fold greater compared to the precursors. According to EIS measurements, pure Li₃PO₄ and LiI resulted in conductivities less than 10⁻³ mS/cm (FIG. 12 and FIG. 13). FIG. 12 depicts electrochemical impedance spectroscopy of various compositions of (1−x)Li₃PO₄-xLiI in (wt. %). FIG. 13 depicts electrochemical impedance spectroscopy of as-milled Li₃PO₄.

The three-fold increase in conductivity indicated that a new phase was formed during mechanochemical synthesis of the precursors which promoted Li-ion hopping between the PO₄³⁻ and I⁻ anions. Furthermore, the Li₃PO₄ and LiI ratio of the composite observed to have a significant role on the conductivity. FIG. 11 shows that the (1−x) Li₃PO₄-x LiI composite produced a conductivity of 0.03 mS/cm when x=0.49. Then as the ratio between Li₃PO₄ to LiI increased, the conductivity increased until a maximum conductivity of around 0.15 mS/cm was reached when x=0.45. However, after this point the conductivity of the composite decreased back to 0.03 mS/cm as x approached 0.42 (FIG. 12).

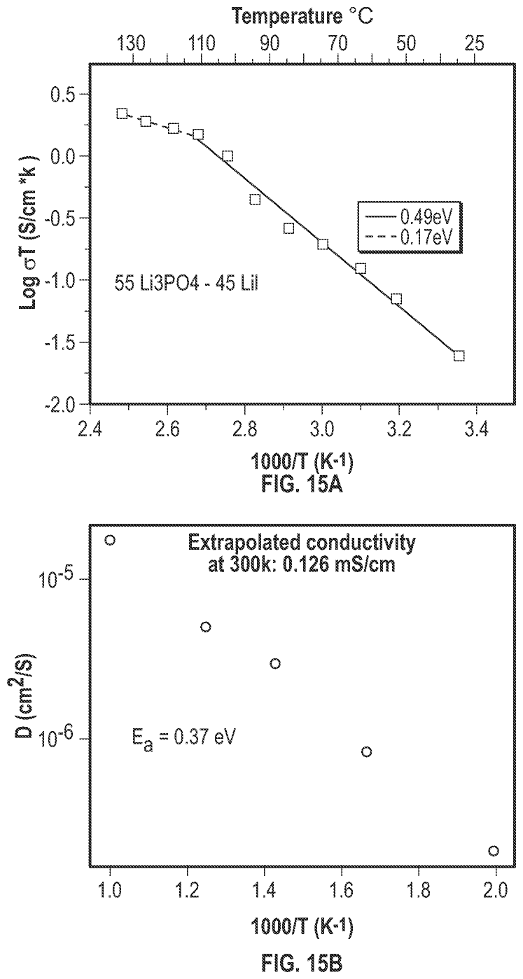

FIG. 14 depicts data collected from electrochemical impedance spectroscopy of as-milled LiI.

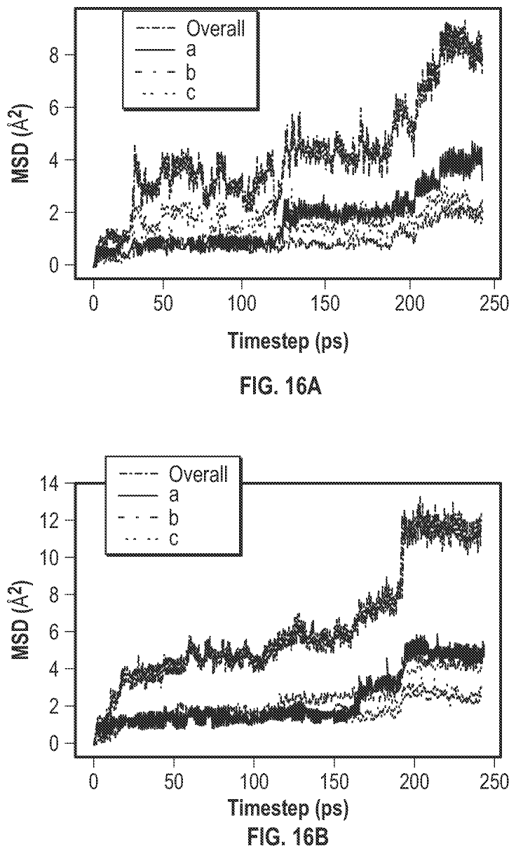

Lithium diffusion was analyzed from electrochemical impedance spectroscopy and AIMD simulations. FIG. 15A depicts an Arrhenius plot of experimental ionic conductivity measurements of 55 wt. % Li₃PO₄—45 wt. % LiI from 25 to 130° C. FIG. 15B depicts calculated lithium ion diffusivity (D) at various temperatures (T) for Li₄PO₄I glassy phase. The activation energy for the 55 wt. % Li₃PO₄—45 wt. % LiI was determined to be 0.49 V at temperatures of 25-110° C. and 0.17 eV at temperatures of 110-130° C. FIG. 14, again, displays the electronic conductivity of the composite of this example.

Overall, the electronic conductivity of the 55Li₃PO₄—45LiI composite was relatively stable and remains at approximately 1×10⁻⁷ S/cm. This was believed to indicate that the conductivity was not strongly attributed by electrons.

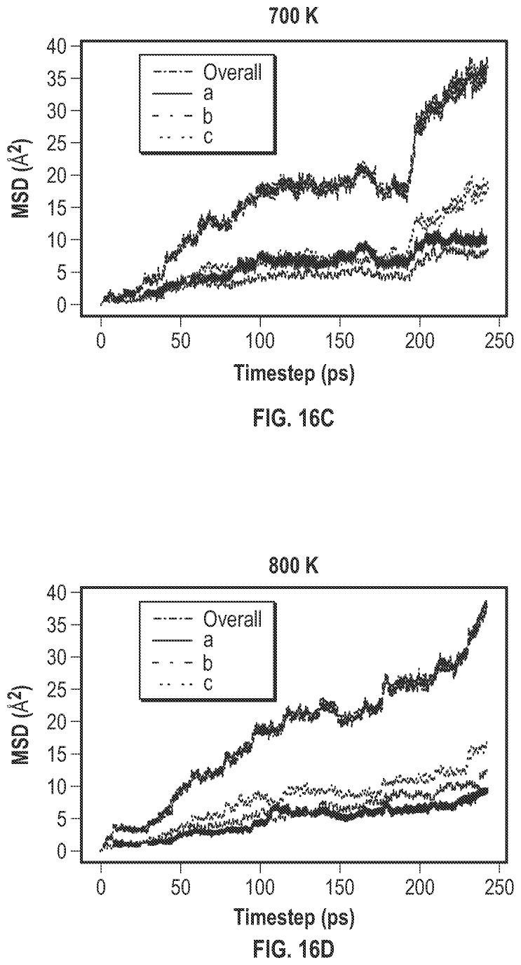

Lithium ion trajectories of Li₄PO₄I using AIMD simulations at various temperatures were collected, and are depicted at FIG. 16A (500 K), FIG. 16B (600 K), FIG. 16C (700 K), FIG. 16D (800 K), and FIG. 16E (1000 K).

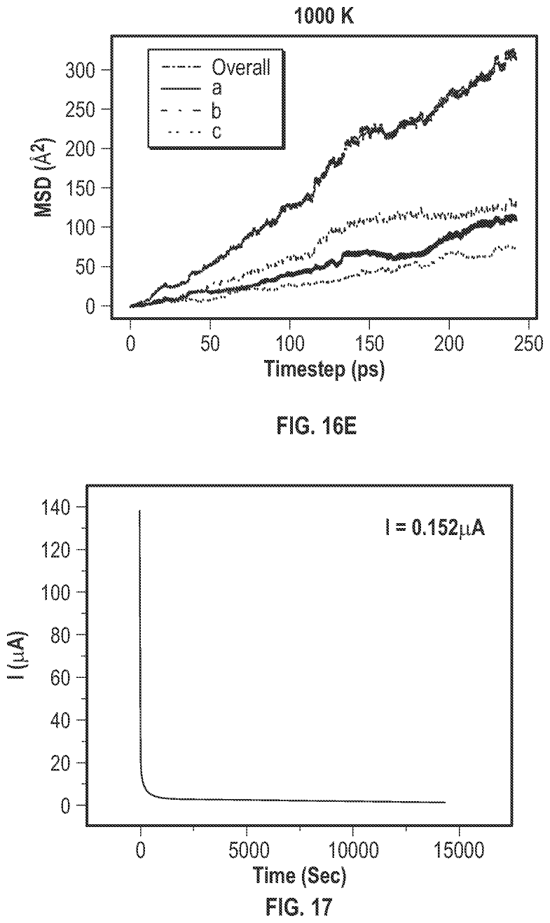

To demonstrate the origin of high ionic conductivity, the foregoing ab initio molecular dynamics (AIMD) simulations was investigated. Since the phase of Li₄PO₄I matched the ⁶Li NMR analysis, this structure was utilized to determine the lithium diffusivity at high temperatures. The calculated activation energy was determined to be 0.37 eV as shown in FIG. 15B. FIG. 17 depicts an electronic conductivity measurement of 55 wt. % Li₃PO₄—45 wt. % LiI composite.

1. A compound of Formula I:
Li_{3+x+y}M₁₋ₓNₓO₄Q_{y} Formula I;
wherein—
(i) 0≤x≤2,
(ii) 0≤y≤1,
(iii) M is an element having an oxidation number of +5,
(iv) N is an element having an oxidation number of +4, and
(v) Q is a halogen having an oxidation number of −1.

2. The compound of claim 1, wherein the compound of Formula I is—
Li₄PO₄I.

3. The compound of claim 1, wherein x is 0, and y is 1.

4. The compound of claim 3, wherein M is P.

5. The compound of claim 3, wherein Q is I.

6. The compound of claim 1, wherein M is selected from the group consisting of P, Sb, and As.

7. The compound of claim 1, wherein N is selected from the group consisting of Si, Ge, and Sn.

8. The compound of claim 1, wherein at least a portion of the compound has a crystalline structure.

9. The compound of claim 1, wherein at least a portion of the compound has an amorphous structure.

10. The compound of claim 1, wherein the compound is in the form of a powder.

11. A composite comprising the compound of Formula I.

12. The composite of claim 11, wherein the composite has an ionic conductivity of at least 0.15 mS/cm at room temperature.

13. The composite of claim 11, wherein the compound of Formula I is Li₄PO₄I, the composite further comprises Li₃PO₄ and LiI, and the compound of Formula I is present in the composite as a metastable phase arranged between disordered Li₃PO₄ and LiI.

14. An electronic device comprising an electrolyte, wherein the electrolyte comprises a compound of claim 1.

15. The electronic device of claim 14, wherein the electronic device is an all-solid-state battery, an electrochemical sensor, or a flow-battery membrane.

16. The electronic device of claim 14, wherein the compound of Formula I is Li₄PO₄I.

17. A method for producing a composite, the method comprising:
contacting Li₃₊ₓM₁₋ₓNₓO₄ and LiQ to form a mixture comprising a compound of Formula I—
Li_{3+x+y}M₁₋ₓNₓO₄Q_{y} Formula I;
wherein—
(i) 0≤x≤2,
(ii) 0≤y≤1,
(iii) M is an element having an oxidation number of +5,
(iv) N is an element having an oxidation number of +4, and
(v) Q is a halogen having an oxidation number of −1.

18. The method of claim 17, wherein the contacting of Li₃₊ₓM₁₋ₓNₓO₄ and LiQ comprises milling the Li₃₊ₓM₁₋ₓNₓO₄ and LiQ.

19. The method of claim 17, wherein, based on the weight of the mixture, about 50 wt % to about 60 wt % of Li₃₊ₓM₁₋ₓNₓO₄ is contacted with about 40 wt % to about 50 wt % of LiQ.

20. The method of claim 17, further comprising subjecting the mixture to electrochemical cycling.
